(19) United States
(12) Patent Application Publication
(10) Pub. No.: US 2025/0013692 A1
(43) Pub. Date: Jan. 9, 2025

(54) INTELLIGENT VIDEO AGGREGATION AND CUSTOMIZATION

(71) Applicant: International Business Machines Corporation, Armonk, NY (US)

(72) Inventors: Tiberiu Suto, POUGHKEEPSIE, NY (US); AVINASH ASTHANA, Paramus, NJ (US); Sarah Missale, New York, NY (US); Michael Nicholas Virnoche, Sandy Springs, GA (US); Jeremy R. Fox, Georgetown, TX (US)

(21) Appl. No.: 18/219,652

(22) Filed: Jul. 8, 2023

(51) Int. Cl. G06F 16/78; G06F 16/783; G06F 40/40; G06V 20/40

(52) U.S. Cl. CPC G06F 16/7867; G06F 16/7844; G06F 40/40; G06V 20/49

(57) ABSTRACT

An example operation may include one or more of identifying a video that is related to a search topic based on previous videos that have been watched on the user device, extracting a snippet of video from among a plurality of snippets of video within the video which is related to the search topic, and outputting an identifier of the snippet of video via a user interface of a user device.

### BACKGROUND

Searching for videos of interest on the Internet can be difficult. For example, a viewer may wish to watch a video of a particular topic, such as a news story that is recorded as part of an online news program. The particular news story may be just one news story among a larger group of news stories that are discussed by the online news program during the video. Pinpointing where the particular news story begins and ends within the video can be difficult. As a result, the viewer typically plays the video or fast-forwards through the video while watching it until the particular news story is encountered. Furthermore, the existence of the particular news story within the video can be difficult to identify when the title of the video does not mention the news story.

### SUMMARY

One example embodiment provides an apparatus that may include a network interface and a processor that may perform one or more of identify a video that is related to a search topic based on one or more keywords associated with the video, extract a snippet of video from among a plurality of snippets of video within the video based on the search topic, and output the snippet of video via a user interface of a user device.

Another example embodiment provides a method that includes one or more of identifying a video that is related to a search topic based on one or more keywords associated with the video, extracting a snippet of video from among a plurality of snippets of video within the video which is related to the search topic, and outputting the snippet of video via a user interface of a user device.

A further example embodiment provides a computer program product comprising a computer readable storage medium having stored thereon instructions, that when executed by a processor, cause the processor to perform one or more of identifying a video that is related to a search topic based on one or more keywords associated with the video, extracting a snippet of video from among a plurality of snippets of video within the video which is related to the search topic, and outputting the snippet of video via a user interface of a user device.

### BRIEF DESCRIPTION OF THE DRAWINGS

FIG. 1 depicts a computing environment, according to example embodiments.

FIGS. 2A-2E are diagrams illustrating processes for generating custom video content according to example embodiments.

FIGS. 3A-3D are diagrams illustrating processes for training and executing a machine learning model according to example embodiments.

FIG. 4A is a diagram illustrating a method of generating a customized video in response to a search request according to example embodiments.

FIG. 4B is a diagram illustrating a method of generating a customized video in response to a search request according to other example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to a process of providing a user with customized video content that is tailored to a search request. The video may be customized by extracting a snippet or a few snippets of video that are specific to a search term in the search request, while removing the other snippets of video that are not specific to the search term. Furthermore, the system may change a title of the video based on the browsing history of the user, thereby enabling more understanding of the video by the user.

For example, the system may perform “on-the-fly” editing of a video to narrowly tailor the content that is played to the user based on the user's browsing history. The resulting video/snippet appears as a single, brand-new video from the user perspective but on the backend, it is edited on the fly with transitions between video snippets (crossfades, etc.). This configuration eliminates the need to store the product since it can just be played back from the browser. In addition, the adjustment of the title for the video becomes more informative and thus more useful to the viewer.

Some of the benefits created by the example embodiments include changing the perception of online videos from a pool of unstructured information to a customized experienced based on a user's preferences and prior viewings in a scalable manner. For example, information from videos that the viewer completed and videos from which the viewer disengaged from may be collected from the viewer's device, such as from a cookie file, a log file, etc. Other information may also be used to modify the video content, including non-obvious factors such as understanding a viewer's communication preferences (e.g., grammar structure, preference for type of speech such as humor analogies, etc.) which can be obtained from the browsing history to identify a set of videos that would be of interest to a viewer based on a topic that the viewer searches for.

In some embodiments, instead of suggesting a customized video or customized set of videos, the system may understand what the viewer currently knows about a topic being searched for and identify a set of information from the customized set of videos that the user does not know about. In addition to helping to educate the viewer, understanding attributes of the viewer ensures a higher probability of the viewer actually completing the video and not disengaging. As another example, in some embodiments, before presenting a customized video, the system may generate a custom title that is informative and captures the user's attention. For example, instead of “15 things you may not know about Machine Learning”, the system may update the title to “6 things that you may not know about unsupervised learning that could help you in your NLP project research.” Thus, the system can modify the title to reflect the number of new items or information, the type of action to perform, a name that is more familiar to the user, etc.

The custom video may be played by the host system and watched over a network by the user device. As another example, the custom video may be downloaded to the user device from the host system and may be played locally on the user device.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

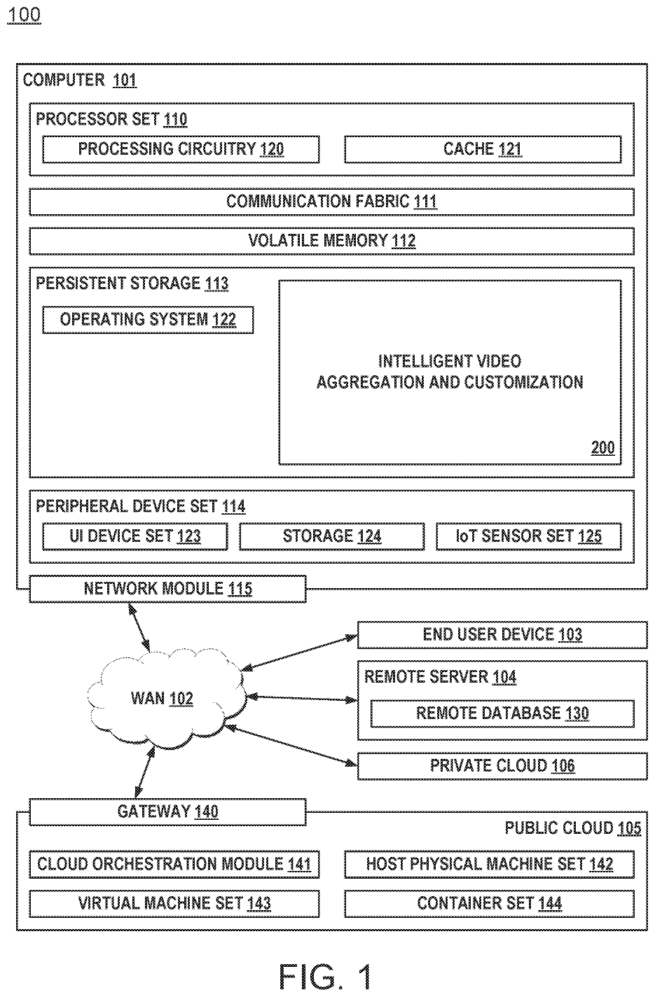

Referring now to FIG. 1, a computing environment 100 is depicted. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for executing at least some of the computer code involved in performing the inventive methods, such as Intelligent Video Aggregation and Customization 200. In addition to block 200, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

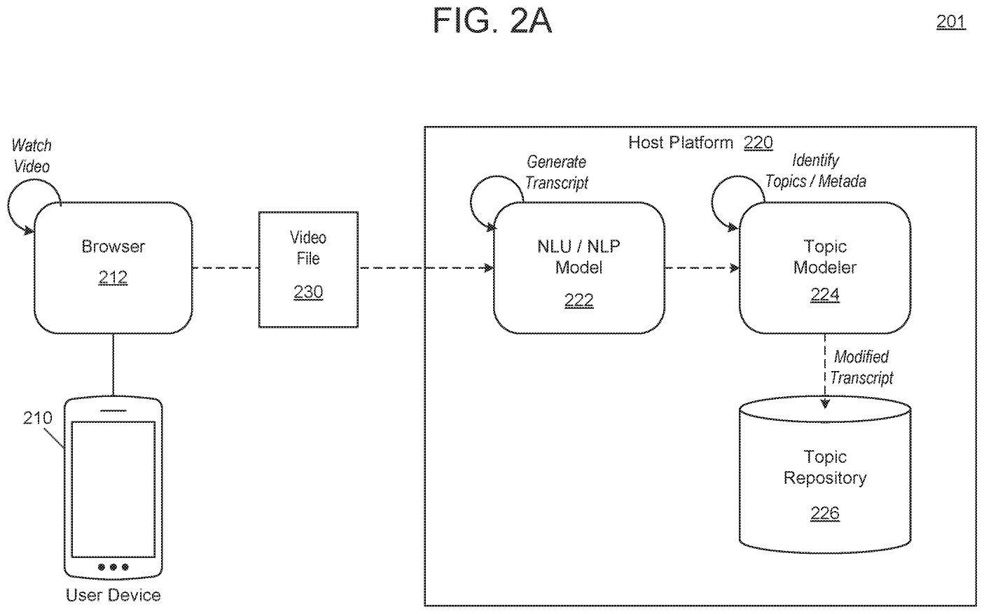

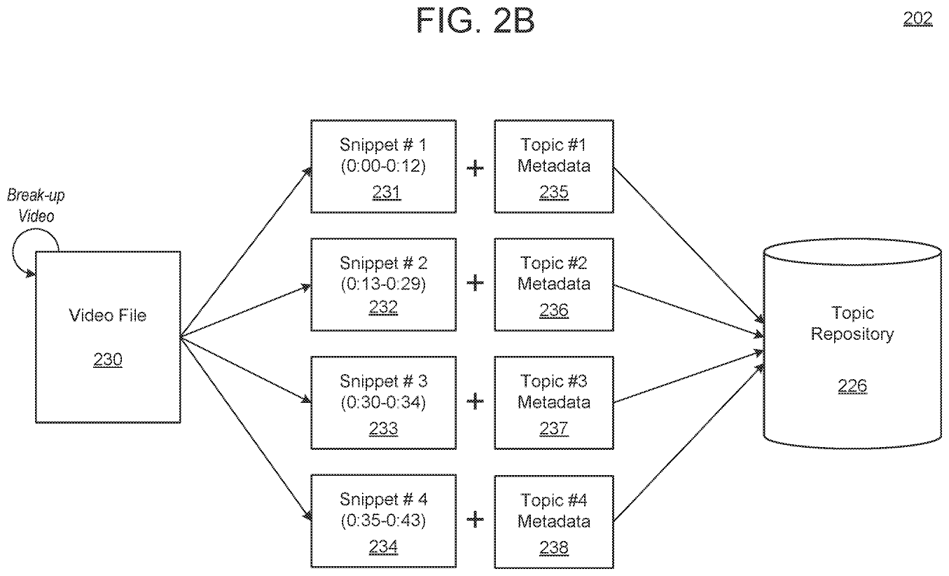

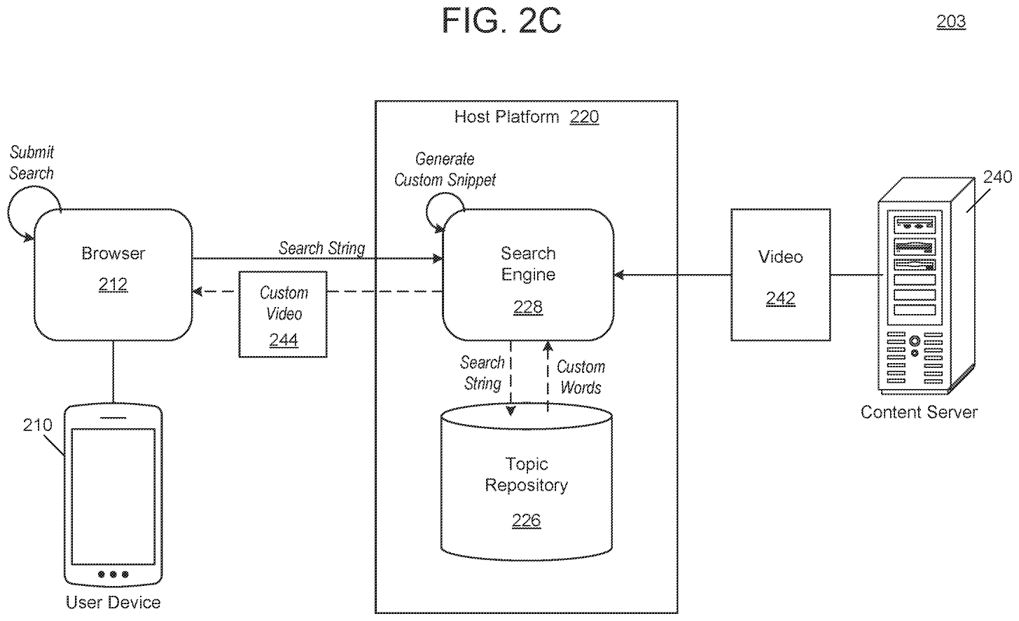

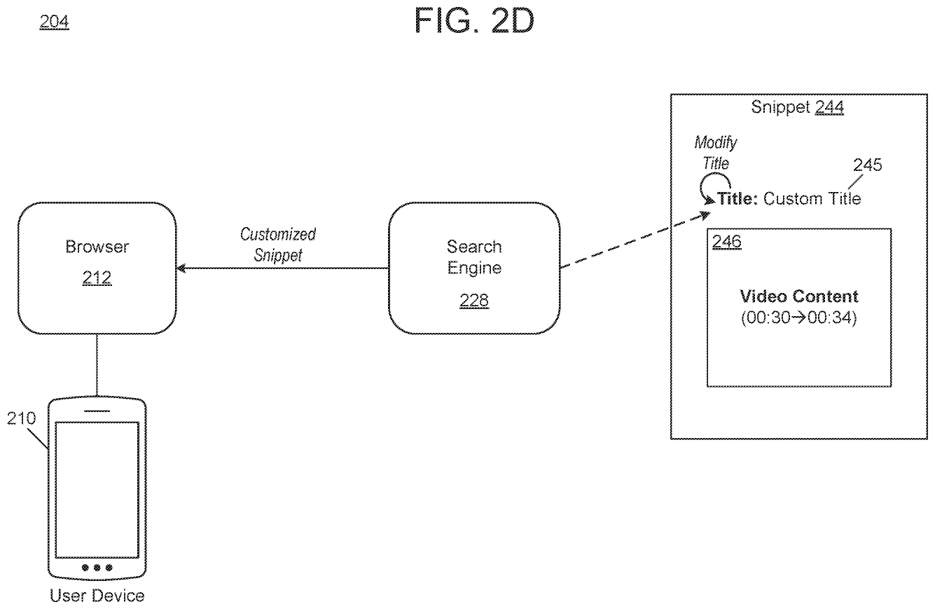

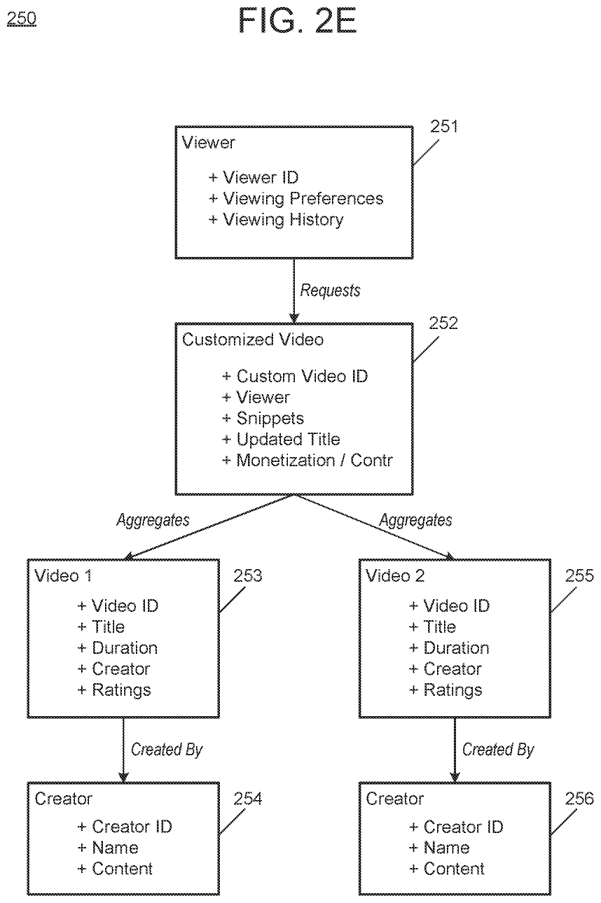

FIGS. 2A-2E illustrate processes for generating custom video content as a search result according to example embodiments. For example, FIG. 2A illustrates a process 201 of a host platform 220 identifying topics that a user gains knowledge of while watching online videos with a user device 210. For example, the host platform 220 may include a communication module (not shown) which is in communication with a browser 212 (e.g., a browser extension, plug-in, etc.) installed on the user device 210, which can play videos generated by the host platform 220. Here, the user may enter search terms into a search bar in the browser 212 which are sent to a search engine 228 of the host platform. The search engine 228 may find and play videos via the browser 212. In response to a video 230 being watched on the user device 210/browser 212, the host system may analyze the video for knowledge gained by the user.

According to various embodiments, as the user watches videos from different sources/platforms, the host platform 220 may use a combination of machine learning (e.g., natural language processing, natural language understanding, etc.) to identify content topics and content details included in the video to generate a corpus of information that the user gains an actual understanding of (i.e., video content that the user has watched). In addition, the host platform 220 can provide dates, times, lengths, etc., at which the videos are viewed.

For example, the host platform 220 may execute a speech-to-text converter on the audio within the video to identify words that are spoken during the video. In addition, the host platform 220 may execute a natural language processing (NLP) model 222 on the words to generate a transcript (text file) of the audio from the video. As another example, the host platform 220 may execute a natural language understanding (NLU) model on the words to generate the transcript. The host platform 220 may execute a topic modeling algorithm 224, such as a Latent Dirichlet Allocation (LDA) algorithm on the transcript to identify a topic associated with a timeframe (such as each second) of video. As such, the topic modeling algorithm 224 may be used to identify snippets of video within the video, including start timestamps and stop timestamps, and topics associated with each of the snippets of video. The transcript of the video may be modified to include the metadata, such as the start/stop timestamps of each snippet of video, the topic(s) associated with the respective snippets, and the like. The resulting transcript (with metadata) may be added to a corpus of knowledge that the user of user device 210 has gained, such as by storing the transcript in a repository 226.

The repository 226 may hold a corpus of knowledge that the user already has (including identifiers of videos, topics, etc., the user has already watched). In some embodiments, the host platform 220 may also infuse additional information into the corpus of knowledge that the user has, including additional interactions of the user with non-video sources such as conversations with others through chat, message, email, etc., reading from web pages, applications, articles, books, etc. and the like. In some embodiments, the host platform 220 may also adjust a memory factor depending on an age of the information stored in the corpus. For example, if information was learned yesterday, it might have a greater recall confidence score than content that was watched six months ago.

FIG. 2B illustrates a process 202 of breaking-up a video 230 into a plurality of snippets of video 231, 232, 233, and 234, based on topics within the video 230. The host platform 220 may execute the NLP model 222 and/or the topic modeling algorithm 224 on the transcript of the video 230 to identify different topics within the video, start/stop times of the topics, and the like. This information can be used to identify the snippet boundaries. For example, each time the topic changes, a snippet boundary may end, and a new snippet boundary may begin (i.e., for the next topic). This process may continue until there are no more topics discussed. In FIG. 2B, the host platform 220 identifies four topics within the video 230 corresponding to the four snippets 231, 232, 233, and 234.

The snippet boundaries may be identified when the topic changes in the video, which can be identified from the audio by the topic modeling algorithm. In addition, the host platform 220 may generate a metadata file for each of the snippets, including metadata files 235, 236, 237, and 238, for the snippets 231, 232, 233, and 234, respectively. The metadata files 235, 236, 237, and 238 may include start and stop times of the respective snippet, a topic identifier (or multiple topic identifiers if there are multiple topics in the snippet), a title of the video, a name of a creator, a name of a viewer, etc. The snippets 231, 232, 233, and 234, may be paired with the metadata files 235, 236, 237, and 238, respectively, and stored in the repository 226.

FIG. 2C illustrates a process 203 of generating a custom video 244 in accordance with an example embodiment. Referring to FIG. 2C, the user may enter a search term or terms into a search bar within the browser 212 and send a search request to the search engine 228. The term or terms may include an alphanumeric string of text and/or characters, which can be interpreted by the search engine 228. In response to receiving the request, the search engine 228 may identify a video 242 (or multiple videos) that corresponds to the term or terms included in the search request. Here, the video 242 may be hosted by a content server 240 that is accessible by the search engine 228 over a computer network. An identifier of the video 242, along with the video itself and other details about the video, may be output on a user interface where the user entered the search terms into the search bar.

Although only one video 242 is shown in FIG. 2C, the search engine 228 may identify multiple videos that match the search criteria. In this case, the user may select portions of the video 242 that can be aggregated together to generate a custom video 244. As another example, the user may pick content from multiple different videos from multiple content creators to be combined to generate the custom video 244 by aggregating different content from the multiple videos. As part of this process, the user may specify a period of time (e.g., start time, stop time, duration, etc.) or topic from each video that the user would like aggregated together. This can occur using controls on the user interface. Thus, the user can selectively generate a video without duplicate content.

The host platform 222 may pull the video 242 from the content server 240 and analyze the video. For example, the host platform 220 may generate a transcript via speech-to-text conversion and NLP processing and perform topic modeling on the transcript of the video 242 to identify a plurality of snippets corresponding to a plurality of topics. In this case, the host system only selects a subset of snippets for the custom video 244 from the video 242 and provides the custom video 244 to the browser 212 on the user device 210. For example, one or more snippets that are unrelated to the search topic (e.g., do not satisfy the search criteria) may be removed from the video 242 to generate the custom video 244. The subset of snippets that remain after the removal of unrelated snippets may be aggregated together to generate the custom video 244.

Furthermore, referring to FIG. 2D, the host platform 220 may analyze existing topics, titles, videos, etc., and modify or otherwise change a title 245 of the custom video 244 to provide the viewer with a better understanding of the content based on previous browsing history of the viewer, prior to providing the custom video to the browser 212. For example, if the title 245 is detected to contain specific, quantifiable information related to a topic the user has previous knowledge of stored in the repository 226, the host system 220 may parse the title using an NLU model and then generate a new title that will be more accurate and relevant to the user. Meanwhile, video content 246 may remain unchanged.

For example, if an initial video title is “21 cooking tips you don't know”, the new title might be changed to “14 cooking tips you didn't know” for a user that the system determined already knows 7 of the cooking tips included in the video. Additionally, the system may generate a new video with the new information and a link the user can click to view this customized video, etc. To generate the custom video, the system may extract the relevant snippets (even if they are not in sequence) while removing irrelevant snippets and the relevant snippets in sequence, reducing the overall playing time of the video and narrowing the content of the video.

Accordingly, the host system described herein can extract relevant video snippets from the one or more videos based, at least in part, on the user's prior viewing preferences and the user's interactions while viewing past videos. Furthermore, the host system may customize the extracted relevant video snippets based on the user's familiarity/knowledge about the content included in the extracted relevant video snippets and combine the customized extracted relevant video snippets to form a custom video.

In addition to playing the video, the host system described herein may also provide a mechanism for aggregating together content from multiple different videos to generate a custom video. As part of this process, the host system may track the contribution of each user that helps design the content. For example, the host system may build an entity-relationship diagram 250, such as shown in FIG. 2E. Here, the diagram 250 includes a plurality of nodes 251, 252, 253, 254, 255, and 256 representing a plurality of entities, respectively, including a viewer, a customized video, a first original video that is used to build the custom video, a creator of the first original video, a second original video that is aggregated with the first original video to generate the custom video, and a creator of the second original video. The system can keep track of what percentage of content is added to the video by which user, thus tracking the percentage contribution of each user's video to the custom video. This contribution may be used to determine ownership or a payment amount.

For example, a viewer may be interested in viewing a particular news story about a recent study on the benefits of solar power and would like to have comprehensive knowledge of this topic. When searching for this news story, the search engine may return seven videos from different creators that match the search criteria. For this example, assume each video is 10 minutes long. If the user watches all 7 videos to ensure they don't miss any facet of the story, it will take 70 minutes of watch time (7 videos*10 minutes/per video). Besides expending a lot of time, the viewing experience might also be boring as there may be significant duplicated content between sources. Perhaps as much as 85% of each video may be duplicated information across videos, with only 15% of the content adding unique information related to the story only present in that source.

In the example embodiments, a new video (custom video represented by item 252) may be generated by aggregating video content from video snippets from these seven videos. Instead of 70 minutes of watch time, the new custom video may be only 15 minutes and would cover all related content related to the story topic across all sources without duplication. Here, the example embodiments can remove 55 minutes of duplicate content from the aggregated videos to generate a more efficient video for the user. For example, the host system may identify which content to exclude based on video content which the viewer has already seen or on information the user may already be aware of. The videos/portions of video content that have been watched by the viewer may be identified from the browsing history of the user device(s) that have been registered with the host system. Accordingly, the user may only receive a video of content that they have not seen before.

In addition to tracking the contribution of each video snippet to the custom video, the example embodiments may also monetize the videos on behalf of the creators. For example, the host system may identify a percentage of snippets of video used and rating of those segments from the user side to apply weightage. For example, a custom video may be created with 70% content from creator A and 30% content from creator B. Normally, this would create a 70/30 monetization split among the creators for any revenue generated by the newly generated video (e.g., downloads, etc.). However, in the example embodiments, the newly created video can be rated by users based on sections of video, not necessarily on the entire video. In this example, if the creator A snippet has a rating twice as high as the creator B snippet, then the split might become 85/15 to allow for the higher contribution of creator A content to the overall video. Furthermore, the system may create an aggregated commerce-based underpinning for the commercial transactions through the monetization process.

The entity-relationship diagram 250 may be generated by creating an ontology tree with terms/keywords from metadata of the user and video. Then, the system may compare the ontology trees to find the commonality. Based on these common features, the system may perform similar analysis against ontology trees created with other videos along with weighted graphs with relevant details and snippets. Additionally, the host system may leverage existing ontology trees to optimize and not run queries that are unnecessary. For example, if the question was “What is ML,” the system may understand based on the user what the user has seen about ML to create the ontology tree. Then it will query it against the next set of relevant results (videos) to compare what information is not in the initial corpus. Based on those results, a new ontology tree is created.

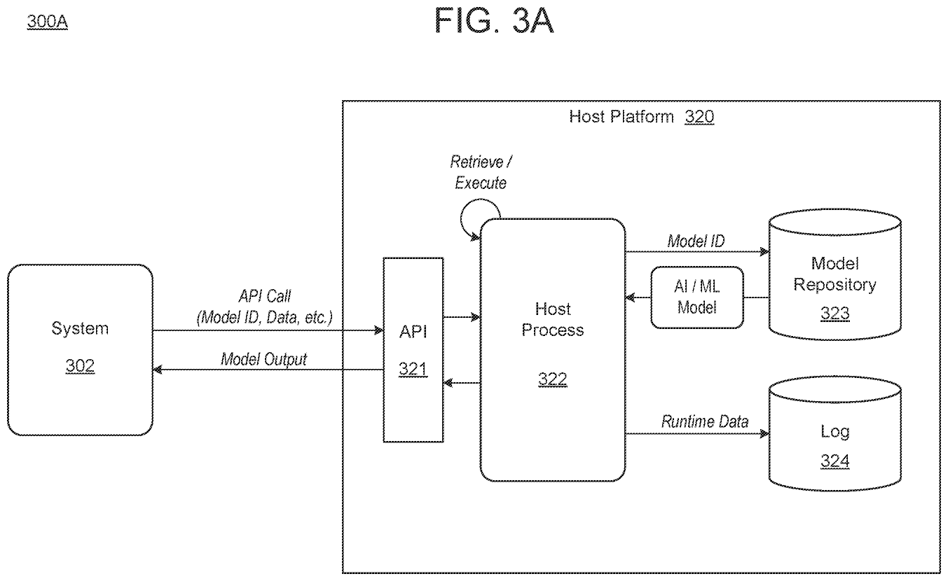

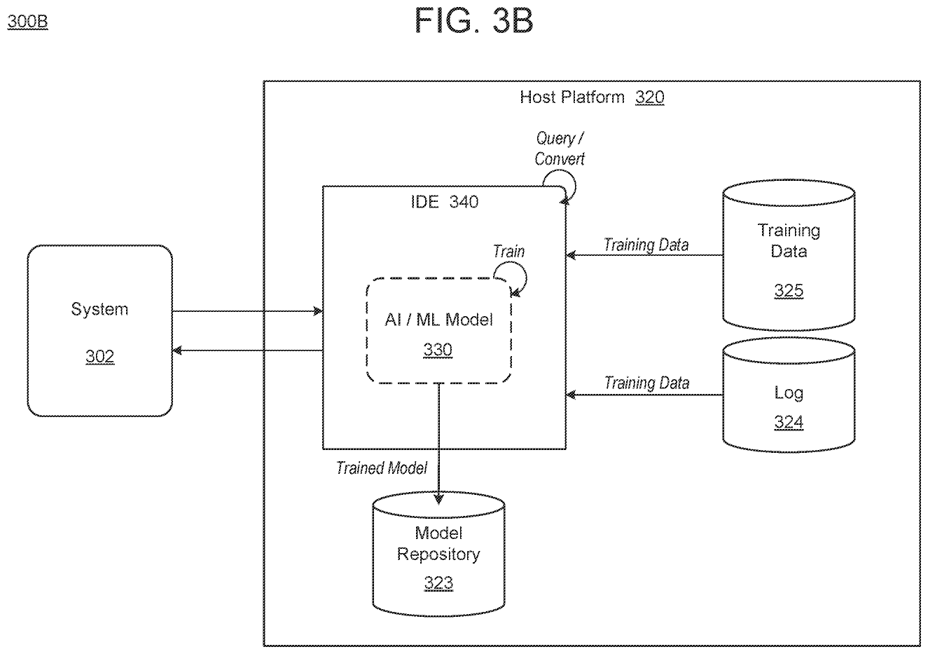

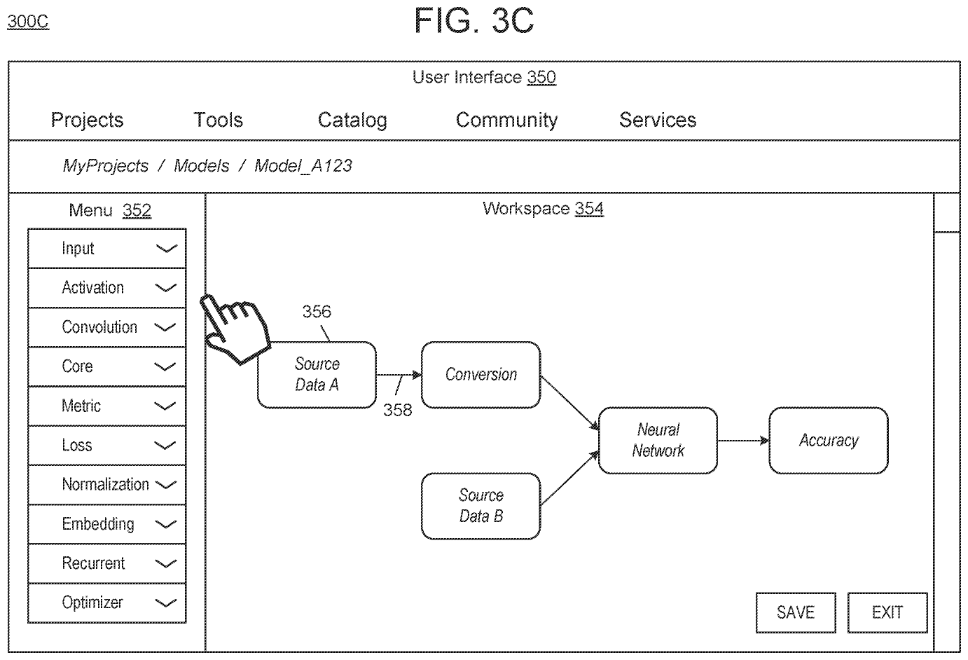

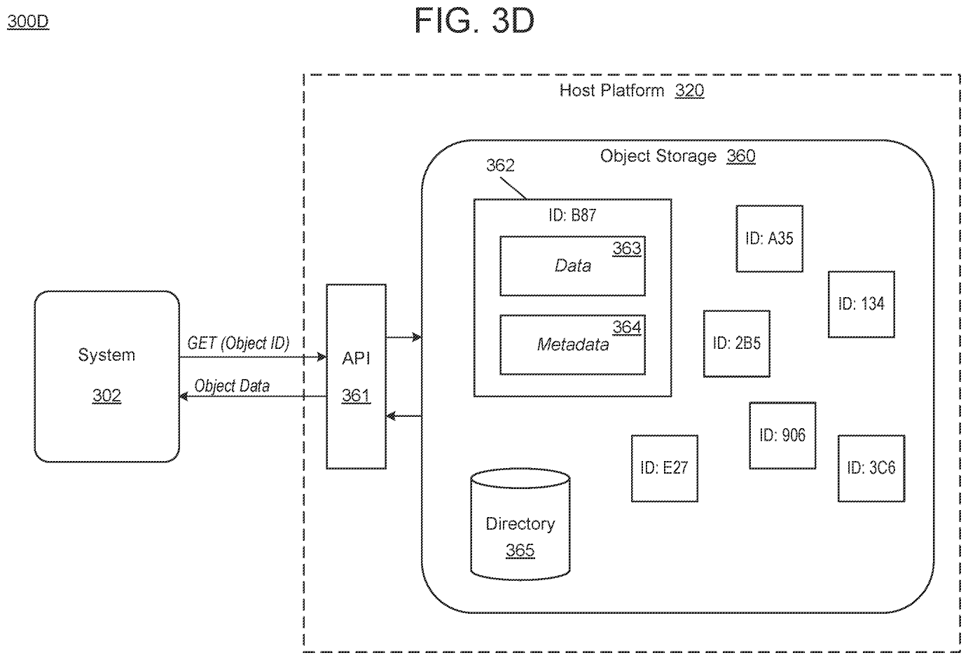

The example embodiments may communicate with a host platform 320 as shown in the examples of FIGS. 3A-3D. For example, a system 302 may contain the logic for performing the methods and processes described herein, including one or more machine learning models, artificial intelligence models, natural language processing models, etc. For example, the host platform 320 may train and execute a natural language processing (NLP) model, a topic modeling algorithm such as Latent Dirichlet Allocation (LDA), and the like. The models used by the host application 224 may be trained and executed as further described herein. The models may be integrated/built into the host application 224 or they may be externally called/accessed by the host application 224. The system 302 may be hosted by or otherwise communicate with the host platform 320 shown in FIGS. 3A, 3B and 3D. Further, the methods, systems, and processes described herein may interact with the processes and systems that are depicted and described in FIGS. 3A-3D.

For example, FIG. 3A illustrates a process 300A of executing a machine learning model via the host platform 320. As an example, the machine learning model may refer to a machine learning model that can map a name of an object (e.g., a video) to a name of a similar object (e.g., a similar video) based on context on the page, speech, etc. The host platform 320 may host a host process 322 within a live runtime environment that is accessible to other software programs, applications, and the like, via a network such as the Internet. Here, the host process 322 may have a URL, endpoint, API, etc., which is publicly available on the Internet.

In this example, the host process 322 may control access to and execution of models that are stored within a model repository 323. For example, the models may include artificial intelligence (AI) models, machine learning models, neural networks, or the like. The system 302 may trigger execution of a model from the model repository 323 via submission of a call to an application programming interface (API) 321 (application programming interface) of the host process 322. The request may include an identifier of a model or models to be executed, a payload of data (e.g., to be input to the model during execution), and the like. The host process 322 may receive the call from the system 302 and retrieve the corresponding model from the model repository 323, deploy the model within a live runtime environment, execute the model on the input data, and return a result of the execution to the system 302. The result of the execution may include an output result from the execution of the model.

In some embodiments, the system 302 may provide feedback from the output provided by the model. For example, a user may input a confirmation that the prediction output by the model is correct or provide notification that the model is incorrect. This information may be added to the results of execution and stored within a log 324. The log data may include an identifier of the input, an identifier of the output, an identifier of the model used, and feedback from the recipient. This information may be used to subsequently retrain the model, for example, using the model development environment shown in the example of FIG. 3B.

In other embodiments, the system 302 may perform one or more of receiving a request from a user device (not shown), where the request includes a search topic, identifying a video that is related to the search topic based on previous videos that have been watched on the user device, extracting a snippet of video from among a plurality of snippets of video within the video which is related to the search topic, and outputting an identifier of the snippet of video via a user interface of the user device.

FIG. 3B illustrates a process 300B of training a machine learning model 330 according to example embodiments. Referring to FIG. 3B, the host platform 320 may host an IDE 340 (integrated development environment) where machine learning models, AI models, and the like may be developed, trained, retrained, and the like. In this example, an integrated development environment (IDE) 340 may include a software application with a user interface accessible by the system 302. For example, the IDE 340 may be embodied as a web application that can be accessed by a device at a network address, URL, etc. As another example, the IDE 340 may be locally or remotely installed on a computing device used by a user.

The system 302 may be used to design a model (via a user interface of the IDE), such as a machine learning model, etc. The model can then be executed/trained based on the training data established via the user interface. For example, the user interface may be used to build a new model. The training data for training such a new model may be provided from a training data store 325 which includes training samples from the web, from customers, and the like. Here, the model is executed on the training data via the host platform 320 to generate a result. The execution of the model causes the model to learn based on the input training data. When the model is fully trained, it may be stored within the model repository 323 via the IDE 340, or the like.

As another example, the IDE 340 may be used to retrain an existing model. Here, the training process may use executional results previously generated/output by the machine learning model 330 (including any feedback, etc.) to retrain the machine learning model 330. For example, predicted outputs that are identified as accurate, best, good, etc., may be distinguished from outputs that are inaccurate, incorrect, bad, etc. One or more of these types of outputs can be identified and used for retraining the model to help the model provide better outputs.

In another example, the system 302 can convert audio from the video into text via a speech-to-text converter, execute a natural language processing (NLP) model on the text to generate a transcript of the video, execute a topic modeling algorithm on the transcript of the video to identify a plurality of snippets of video within the video corresponding to a plurality of different search topics, respectively, and store the plurality of snippets with a plurality of metadata identifying the plurality of different search topics, respectively.

FIG. 3C illustrates a process 300C of designing a new machine learning model via a user interface of the system 302 according to example embodiments. As an example, the system 302 may be output as part of the software application which interacts with the IDE 340 shown in FIG. 3B, however, embodiments are not limited thereto. Referring to FIG. 3C, a user can use an input mechanism to make selections from a menu 352 of a user interface 350 to add pieces/components to a model being developed within a workspace 354 of the user interface 350.

In the example of FIG. 3C, the menu 352 includes a plurality of graphical user interface (GUI) menu options which can be selected to drill-down into additional components that can be added into the model design shown in the workspace 354. Here, the GUI menu includes options for adding features such as neural networks, machine learning models, AI models, data sources, conversion processes (e.g., vectorization, encoding, etc.), analytics, etc. The user can continue to add features to the model and connect them using edges or other means to create a flow within the workspace 354. For example, the user may add a node 356 to a diagram of a new model within the workspace 354. For example, the user may connect the node 356 to another node in the diagram via an edge 358, creating a dependency within the diagram. When the user is done, the user can save the model for subsequent training/testing.

In another example, inputs can be received via the user interface 350. For example, two or more video snippets from among the plurality of different video snippets can be selected and content from the two or more video snippets can be aggregated to generate a custom video, and play the custom video via the user interface 350 of the user device 210.

FIG. 3D illustrates a process 300D of accessing an object 362 from an object storage 360 of the host platform 320 according to example embodiments. For example, the object storage 360 may store data that is used by the AI models and machine learning (ML) models 222, 330, training data, expected outputs for testing, training results, and the like. The object storage 360 may also store any other kind of data. Each object may include a unique identifier, a data section 363, and a metadata section 364, which provides for descriptive context associated with the data, including data that can later be extracted for purposes of machine learning. The unique identifier may uniquely identify an object with respect to all other objects in the object storage 360. The data section 363 may include unstructured data such as web pages, digital content, images, audio, text, and the like.

Instead of breaking files into blocks stored on disks in a file system, the object storage 360 handles objects as discrete units of data stored in a structurally flat data environment. Here, the object storage may not use folders, directories, or complex hierarchies. Instead, each object may be a simple, self-contained repository that includes the data, the metadata, and the unique identifier that the system 302 can use to locate and access it. In this case, the metadata is more descriptive than with a file-based approach. The metadata can be customized with additional context that can later be extracted and leveraged for other purposes, such as data analytics.

The objects that are stored in the object storage 360 may be accessed via an API 361. The API 361 may be a Hypertext Transfer Protocol (HTTP)-based RESTful API (also known as a RESTful Web service). The API 361 can be used by the system 302 to query an object's metadata to locate the desired object (data) via the Internet from anywhere, on any device. The API 361 may use HTTP commands such as “PUT” or “POST” to upload an object, “GET” to retrieve an object, “DELETE” to remove an object, and the like.

The object storage 360 may provide a directory 365 that uses the metadata of the objects to locate appropriate data files. The directory 365 may contain descriptive information about each object stored in the object storage 360, such as a name, a unique identifier, creation time stamp, collection name, etc. To query the object within the object storage 360, the system 302 may submit a command, such as an HTTP command, with an identifier of the object 362, a payload, etc. The object storage 360 can store identified contributions of each video snippet from among the two or more video snippets to the custom video.

For example, the system 302 may query the object storage 360 via the API 361 with a predefined command to retrieve data from the object storage 360. Here, the query may comprise an identifier of an object from among the objects stored in the object storage 360. The object storage 360 may process the query and return object data from a corresponding object that matches the identifier within the object storage 360. The data may include customer data, personal data, code, model training data, models themselves, or the like.

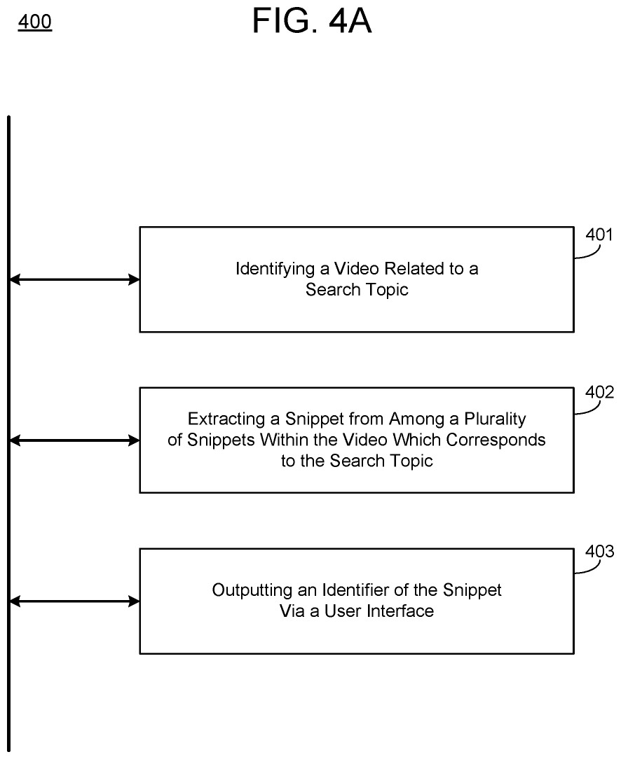

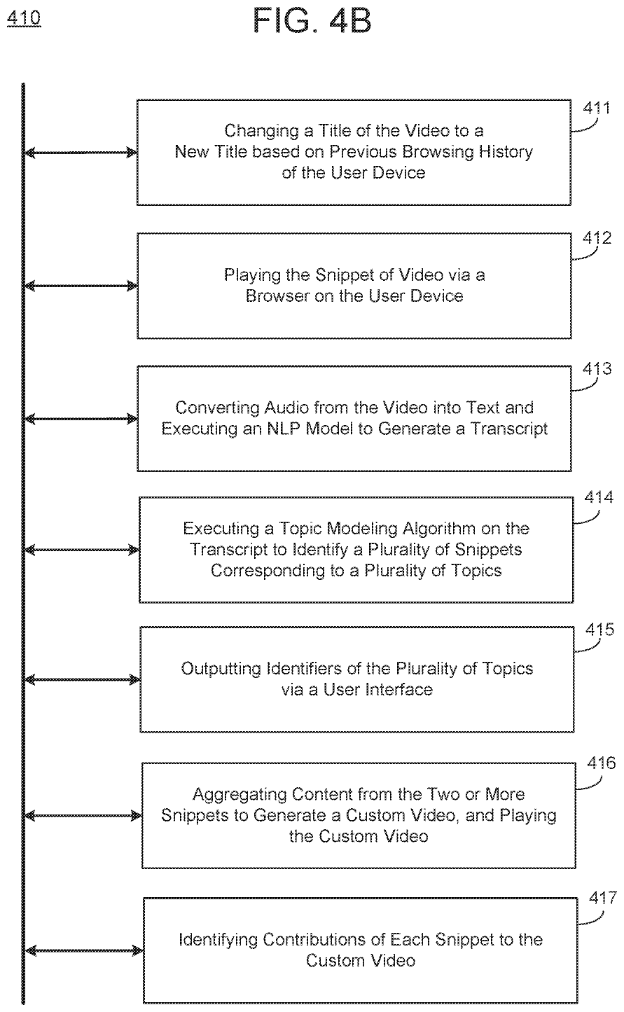

FIG. 4A illustrates a method 400 of generating a customized video search result according to example embodiments, and FIG. 4B illustrates a method 410 of generating a customized video search result according to example embodiments. Referring to FIG. 4A, in 401, the method may include identifying a video that is related to a search topic based on a previous video that has been watched on the user device. In 402, the method may include extracting a snippet of video from among a plurality of snippets of video within the video, which is related to the search topic. In 403, the method may include outputting an identifier of the snippet of video via a user interface of the user device.

Referring now to FIG. 4B, in some embodiments, in 411 the method may include changing a title of the video to a new title based on previous browsing history of the user device. In 412, the method may further include playing the snippet of video via a video player embedded within a browser on the user device. In 413, the identifying may include converting audio from the video into text via a speech-to-text converter and executing a natural language processing (NLP) model on the text to generate a transcript of the video. In 414, the identifying may further include executing a topic modeling algorithm on the transcript of the video to identify a plurality of snippets of video within the video corresponding to a plurality of different search topics, respectively, and storing the plurality of snippets with a plurality of metadata identifying the plurality of different search topics, respectively, in storage.

In 415, the method may further include outputting identifiers of a plurality of different video snippets and a plurality of topics corresponding to the plurality of different video snippets via the user interface. In 416, the method may further include receiving inputs via the user interface selecting two or more video snippets from among the plurality of different video snippets, aggregating content from the two or more video snippets to generate a custom video, and playing the custom video via the user interface of the user device. In 417, the method may include identifying a contribution of each video snippet from among the two or more video snippets to the custom video and storing the determined contributions in storage.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Although an exemplary embodiment of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device, and/or via a plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules in order to more particularly emphasize their implementation independence. For example, a module may be implemented as a hardware circuit comprising custom, very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations, which, when joined logically together, comprise the module and achieve the stated purpose for the module. Further, modules may be stored on a computer readable medium, which may be, for instance, a hard disk drive, flash device, random access memory (RAM), tape, or any other such medium used to store data.

Indeed, a module of executable code could be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed is:

1. An apparatus comprising:
a processor configured to:
identify a video that is related to a search topic based on one or more keywords associated with the video,
extract a snippet of video from among a plurality of snippets of video within the video based on the search topic, and
output the snippet of video via a user interface of a user device.

2. The apparatus of claim 1, wherein the processor is further configured to customize the snippet of video based on previous browsing history of the user device prior to outputting the snippet of video via the user interface.

3. The apparatus of claim 1, wherein the processor is further configured to play the snippet of video via a video player embedded within a browser on the user device.

4. The apparatus of claim 1, wherein the processor is further configured to convert audio from the video into text via a speech-to-text converter, and execute a natural language processing (NLP) model on the text to generate a transcript of the video.

5. The apparatus of claim 4, wherein the processor is further configured to execute a topic modeling algorithm on the transcript of the video to identify a plurality of snippets of video within the video corresponding to a plurality of different search topics, respectively, and store the plurality of snippets with a plurality of metadata identifying the plurality of different search topics, respectively.

6. The apparatus of claim 1, wherein the processor is further configured to output identifiers of a plurality of different video snippets and a plurality of topics corresponding to the plurality of different video snippets via the user interface.

7. The apparatus of claim 6, wherein the processor is further configured to receive inputs via the user interface selecting two or more video snippets from among the plurality of different video snippets, aggregate content from the two or more video snippets to generate a custom video, and play the custom video via the user interface of the user device.

8. The apparatus of claim 7, wherein the processor is further configured to identify a contribution of each video snippet from among the two or more video snippets to the custom video, and store the identified contributions in storage.

9. A method comprising:
identifying a video that is related to a search topic based on one or more keywords associated with the video;
extracting a snippet of video from among a plurality of snippets of video within the video which is related to the search topic; and
outputting the snippet of video via a user interface of a user device.

10. The method of claim 9, wherein the method further comprises customizing the snippet of video based on previous browsing history of the user device prior to outputting the snippet of video via the user interface.

11. The method of claim 9, wherein the method further comprises playing the snippet of video via a video player embedded within a browser on the user device.

12. The method of claim 9, wherein the identifying comprises converting audio from the video into text via a speech-to-text converter, and executing a natural language processing (NLP) model on the text to generate a transcript of the video.

13. The method of claim 12, wherein the identifying further comprises executing a topic modeling algorithm on the transcript of the video to identify a plurality of snippets of video within the video corresponding to a plurality of different search topics, respectively, and storing the plurality of snippets with a plurality of metadata identifying the plurality of different search topics, respectively, in storage.

14. The method of claim 9, wherein the method further comprises outputting identifiers of a plurality of different video snippets and a plurality of topics corresponding to the plurality of different video snippets via the user interface.

15. The method of claim 14, wherein the method further comprises receiving inputs via the user interface selecting two or more video snippets from among the plurality of different video snippets, aggregating content from the two or more video snippets to generate a custom video, and playing the custom video via the user interface of the user device.

16. The method of claim 15, wherein the method further comprises identifying a contribution of each video snippet from among the two or more video snippets to the custom video, and storing the identified contributions in storage.

17. A computer program product comprising a computer readable storage medium having stored thereon instructions, that when executed by a processor, cause the processor to perform:
identifying a video that is related to a search topic based on one or more keywords associated with the video;
extracting a snippet of video from among a plurality of snippets of video within the video which is related to the search topic; and
outputting the snippet of video via a user interface of a user device.

18. The computer program product of claim 17, wherein the processor is further configured to perform customizing the snippet of video based on previous browsing history of the user device prior to outputting the snippet of video via the user interface.

19. The computer program product of claim 17, wherein the processor is further configured to perform playing the snippet of video via a video player embedded within a browser on the user device.

20. The computer program product of claim 17, wherein the processor is further configured to perform comparing the content of the extracted video snippet to a browsing history of the user device to identify similar content as the extracted video snippet, determine a recall confidence of the similar content, and store the recall confidence in storage.
